(19) United States
(12) Patent Application Publication
(10) Pub. No.: US 2013/0105735 A1
(43) Pub. Date: May 2, 2013

(54) THERMALLY INDUCED FLASH SYNTHESIS OF PHOTOLUMINESCENT COMPOSITIONS

(71) Applicants: Willard Scott Rader, Sherwood, OR (US); Robert William Hepburn, Sherwood, OR (US)

(72) Inventors: Willard Scott Rader, Sherwood, OR (US); Robert William Hepburn, Sherwood, OR (US)

(21) Appl. No.: 13/283,541

(22) Filed: Oct. 27, 2011

(51) Int. Cl. C09K 11/80; B05D 5/06; C23C 4/12

(52) U.S. Cl. 252/301.4 R; 427/446; 427/453

(57) ABSTRACT

A process is disclosed for the production of persistent phosphors, comprising exposing particles of phosphor precursors for a short time to a heat source selected from a particle plasma and an open flame arising from the combustion of hydrocarbons. A process for coating a substrate with persistent phosphors is also disclosed, comprising directing a stream of phosphor precursor particles for a short time through the same types of heat source toward the substrate. Preferred phosphors are Strontium Aluminate-based doped with Dysprosium and Europium.

### BACKGROUND OF THE INVENTION

The production of persistent phosphors for use in low visible light applications, in light-emitting diodes, in cathode ray tubes, in fluorescent lamps and in plasma panel displays is well known and generally involves the application of extremely high temperatures to phosphor precursor particles for an extended period of time in a reducing atmosphere such as hydrogen and/or carbon monoxide mixed with one or more inert gases, sometimes followed by annealing. Common drawbacks to such processes include the high energy requirements and the difficulty and expense of creating and maintaining a reducing atmosphere of a specific composition. There is therefore a need in the art for a simple process of making persistent phosphors that does not suffer from such drawbacks. This need is met by the present invention, which is summarized and described in detail below.

### BRIEF SUMMARY OF THE INVENTION

According to the present invention there is provided a process of making a photoluminescent composition comprising the steps:
(a) providing particles of at least one phosphor precursor; and
(b) heating the particles of step (a) with a heat source selected from
   (i) a particle plasma and
   (ii) an open flame produced by the combustion of air or oxygen and a hydrocarbon fuel.

A second aspect of the invention is the provision of the persistent phosphor product of the foregoing process.

A third aspect of the invention is the provision of a process for deposition of a photoluminescent coating on a substrate comprising the steps:
(a) providing a substrate;
(b) providing particles of at least one phosphor precursor;
(c) forming a stream of said particles of step (b); and
(d) directing said stream of step (c) toward said substrate of step (a) and through a heat source selected from
   (i) a particle plasma and
   (ii) an open flame produced by the combustion of air or oxygen and a hydrocarbon fuel.

A fourth aspect of the invention is the provision of the phosphor-coated substrate product of the foregoing coating process.

The foregoing and other objectives, features, and advantages of the invention will be more readily understood upon consideration of the following detailed description of the invention.

### DETAILED DESCRIPTION OF PREFERRED EMBODIMENTS

### Phosphor Precursors

Virtually any known compound or combination of compounds that, following the sintering process detailed herein, is capable of exhibiting luminescence, that is, phosphorescence and/or fluorescence and exposure to radiation is suitable for use as a phosphor precursor in the present invention. Exemplary phosphor precursors are those set forth in U.S. Pat. Nos. 7,001,537, 7,427,365 and 7,959,827, the disclosures of which are incorporated herein by reference.

Particularly preferred phosphor precursors are Strontium (Sr) aluminate-based that have been doped with Dysprosium (Dy) and Europium (Eu) of the general formula SrₓAl_{y}O_{z}:Dy³⁺Eu²⁺ where x, y and z are integers of from 1 to 23. The synthesis of the above compound is set forth in U.S. Pat. No. 7,427,365, the synthesis disclosure of which is incorporated herein by reference. In general, the synthesis comprises mixing the precursors either dry or in a slurry. Preferred ranges of these components are SrCO₃ 35 to 60 wt %, Al₂O₃ 35 to 60 wt %, Eu₂O₃ 1.5 to 5.5 wt % and Dy₂O₃ 1.5 to 5.5 wt %. Other salts besides carbonate will work for Sr, while salts of Al, Eu and Dy will work in place of the oxides of those compounds.

As to the particle plasma heat source embodiment, conventional processes and instruments capable of generating a plasma spray, typically with an inert gas such as argon, helium, neon, or mixtures of the same may be used in the flash synthesis of the invention. In a preferred embodiment, particles of phosphor precursors are flowed through a plasma spray gun capable of creating charged particles of the inert gas(es) and temperatures up to 10,000° C. and either deposited in a heat-resistant container or directed at a substrate to thereby deposit a film of photoluminescent particles on the substrate. The particles are exposed to the plasma for a very short time period, on the order of 0.1 to 10 milliseconds. In a particularly preferred embodiment, the phosphor precursor particles are first formed into a composition with an organic binder such as the copolymer poly[(isobutylene-alt-maleic acid, salt)-co-(isobutylene-alt-maleic anhydride)] (commercially available from Sigma Aldrich of St. Louis, Mo.), then spray-dried to form a substantially homogeneous particulate composition.

As to the open flame heat source embodiment, any hydrocarbon capable of achieving a flame temperature hot enough to sinter the phosphor precursor(s) in a reductive environment is suitable. Specific examples of such fuels include methane, natural gas, ethane, acetylene, propane, methyl acetylene, propylene, propadiene, butane, and mixtures thereof. Particularly preferred fuels are acetylene, propylene and a mixture of methyl acetylene and propadiene (MAPP). The particles are exposed to the open flame for 5 to 120 seconds, preferably from 30 to 60 seconds.

### EXAMPLES

### Examples 1-20

Analytical grades of SrCO₃, Al₂O₃, Eu₂O₃ and Dy₂O₃ were obtained in dry powdered form then mixed in a laboratory jar mill for one hour. The composition in wt % of this four-component mixture was SrCO₃ 35.1, Al₂O₃ 58.1, Eu₂O₃ 3.3 and Dy₂O₃ 3.5. For Examples 9-20, 2 wt % Boric Acid was added to the mixture as a flux. Five grams of the phosphor precursor mixture was placed in a 30 mL ceramic crucible and exposed to an open flame produced by the combustion of oxygen and the fuel noted in Table 1 for the period of time noted in Table 1. After cooling, each mixture was exposed to a battery of four 32 W fluorescent lightbulbs for 12 hours, placed in a dark room and visually observed for up to two hours for luminescence. For comparison, the commercially available powdered phosphor Ultra Green V10 from Glow, Inc. of Serern, Md. was also irradiated in the same way and observed for luminescence. The results are reported in Table 1.

TABLE 1

| | | Flame | | | | |
|---|---|---|---|---|---|---|
| Ex. | Flame | Duration | Luminescence | | | |
| No. | Type | (Seconds) | 0 min | 30 min | 60 min | 120 min |
| 1 | A/N | 5 | ++ | 0 | 0 | 0 |
| 2 | A/N | 30 | ++ | + | 0 | 0 |
| 3 | A/N | 60 | ++ | ++ | + | + |
| 4 | A/C | 5 | ++ | 0 | 0 | 0 |
| 5 | A/C | 30 | ++ | + | 0 | 0 |
| 6 | A/C | 60 | ++ | ++ | + | + |
| 7 | P/C | 60 | ++ | + | 0 | 0 |
| 8 | P/N | 60 | ++ | + | 0 | 0 |
| 9 | A/N | 5 | ++ | ++ | 0 | 0 |
| 10 | A/N | 30 | ++ | ++ | + | + |
| 11 | A/N | 60 | ++ | ++ | + | + |
| 12 | A/C | 5 | ++ | ++ | + | + |
| 13 | A/C | 30 | ++ | ++ | + | + |
| 14 | A/C | 60 | ++ | ++ | + | + |
| 15 | A/O | 60 | + | 0 | 0 | 0 |
| 16 | Prop | 60 | ++ | 0 | 0 | 0 |
| 17 | But | 60 | + | 0 | 0 | 0 |
| 18 | P/N | 60 | ++ | ++ | + | + |
| 19 | P/O | 60 | + | 0 | 0 | 0 |
| 20 | P/C | 60 | ++ | ++ | 0 | 0 |
| C | None | n/a | ++ | ++ | ++ | ++ |

Notes to Table 1
++: readily visible
+: visible but not as distinct as ++
0: none visible
C: control of Ultra Green V10
A/N: a mixture of acetylene and oxygen wherein the tip of the inner cone is at about 3300° C.
A/C: acetylene-rich mixture of acetylene and oxygen characterized by three distinct flame zones (inner core, white feather-shaped portion and blue outer core) wherein the tip of the inner core is at about 2800° C.
A/O: oxygen-rich mixture of acetylene and oxygen wherein the tip of the inner core is at about 3800° C.
P/N: a mixture of propylene and oxygen wherein the tip of the inner core is at about 2870° C.
P/C: propylene-rich mixture of propylene and oxygen wherein the tip of the inner core is at about 2435° C.
P/O: oxygen-rich mixture of propylene and oxygen wherein the tip of the inner core is at about 3300° C.
But: a mixture of butane and oxygen wherein the tip of the inner core is at about 1970° C.
Prop: a mixture of propane and oxygen wherein the tip of the inner core is at about 1955° C.

### Examples 21-23

Analytical grades of SrCl₂.6H₂O, Al₂O₃, CeO₂ and Boric Acid (as a flux) were obtained in dry powder form and mixed together as in Examples 1-20 to form phosphor precursors. The composition in wt % of this mixture was SrCl₂.6H₂O 16.9, Al₂O₃ 77.6, CeO₂ 0.8 and Boric Acid 4.8. Three 5 g samples of this mixture were sintered for 30 seconds with acetylene flames varying from oxygen-poor to oxygen-rich as in Examples 1-20, then exposed to fluorescent light and observed for luminescence. The results are shown in Table 2.

TABLE 2

| Ex. No. | Flame Type | Result |
|---|---|---|
| 21 | A/C | light blue flourescence |
| 22 | A/N | light blue flourescence |
| 23 | A/O | light blue flourescence |

### Examples 24-26

A phosphor precursor mixture was prepared in dry powder form as in Examples 1-20 comprising 43.5 wt % Al₂O₃, 4.3 wt % CeO₂, 43.5 wt % Y₂O₃ and 8.7 wt % Boric Acid (as a flux). Three 5 g samples of this mixture were sintered and exposed to fluorescent light as in Examples 21-23, and observed for luminensence. The results are shown in Table 3.

TABLE 3

| Ex. No. | Flame Type | Result |
|---|---|---|
| 24 | A/C | bright orange-brown flourescence |
| 25 | A/N | bright orange-brown flourescence |
| 26 | A/O | bright orange-brown flourescence |

### Examples 27-28

The four-component mixture of Examples 1-20 was prepared with 2 wt % Boric Acid as a flux. Sixty wt % of this mixture was dispersed in water with 2 wt % poly[(isobutylene-alt-maleic acid, salt)-co-(isobutylene-alt-maleic anhydride)] as a binder, then spray-dried in a Model FOC-20 spray dryer from Ohkawara Kakohki Co. of Yokohama, Japan. The resulting spray-dried powder was then fluidized with a stream of argon and passed through an SG-100 plasma spray gun from Praxair of Danbury, Conn., where it was subjected to a particle plasma of equal parts argon and helium for approximately 5 milliseconds using a current of 1000 Amp and voltage of 32V for Example 27 and 900 Amp and 38V for Example 28. The plasma spray gun was at a distance of 120mm from an aluminum substrate for Example 27 and at 90 mm for Example 28. In both cases, a coating approximately 200 microus thick was deposited on the substrate. Following cooling, the two substrates were illuminated as in Examples 1-20 and observed for luminescence; both exhibited luminescence for about 20 seconds following exposure to the illumination.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A process of making a photoluminescent composition comprising the steps:
(a) providing particles of a phosphor precursor; and
(b) heating said particles of step (a) with a heat source selected from
(i) a particle plasma and
(ii) an open flame produced by the combustion of oxygen or air and a hydrocarbon fuel.

2. The process of claim 1 wherein said heat source of step (b) is a particle plasma and said heating is conducted for 0.1 to 10 milliseconds.

3. The process of claim 1 wherein said heat source of step (b) is said open flame and said heating is conducted for 5 to 120 seconds.

4. The process of claim 3 wherein said heating is conducted for 30 to 60 seconds.

5. The process of claim 3 wherein said fuel in step (b) is an open flame produced by the combustion of air or oxygen and a gaseous hydrocarbon fuel selected from the group consisting of methane, natural gas, ethane, acetylene, propane, methyl acetylene, propylene, propadiene, butane, and mixtures thereof.

6. The process of claim 5 wherein said fuel is selected from the group consisting of acetylene, propylene and a mixture of methyl acetylene and propadiene.

7. The process of claim 1 wherein said particles of step (a) comprise a mixture of oxides and salts of Al, Sr, Eu and Dy.

8. The process of claim 7 wherein said mixture comprises Al₂O₃, SrCO₃, Eu₂O₃ and Dy₂O₃.

9. The process of claim 8 wherein the phosphor SrₓAl_{y}O_{z}:Eu⁺², Dy⁺³ is produced, wherein x, y and z are integers from 1 to 23.

10. The product of the process of claim 1.

11. A process for deposition of a photoluminescent coating on a substrate comprising the steps:
(a) providing a substrate;
(b) providing particles of a phosphor precursor;
(c) forming a stream of said particles of step (b);
(d) directing said stream of step (c) toward said substrate of step (a) and through a heat source selected from
(i) a particle plasma and
(ii) an open flame produced by the combustion of oxygen or air and a hydrocarbon fuel.

12. The process of claim 11 wherein said substrate is selected from Aluminum, Borosilicate glass, Germanium, Silicon and steel.

13. The process of claim 11 wherein said heat source of step (d) is a particle plasma and said heating is conducted for 0.1 to 10 milliseconds.

14. The process of claim 11 wherein said heat source of step (d) is said open flame and said heating is conducted for 5 to 120 seconds.

15. The process of claim 14 wherein said heating is conducted for 30 to 60 seconds.

16. The process of claim 11 wherein said fuel in step (d) is selected from the group consisting of methane, natural gas, ethane, acetylene, propane, methyl acetylene, propylene, propadiene, butane, and mixtures thereof.

17. The process of claim 16 wherein said fuel is selected from the group consisting of acetylene, propylene and a mixture of methyl acetylene and propadiene.

18. The process of claim 11 wherein said particles of step (b) comprise a mixture of oxides and salts of Al, Sr, Eu and Dy.

19. The process of claim 18 wherein said mixture comprises Al₂O₃, SrCO₃, Eu₂O₃ and Dy₂O₃.

20. The process of claim 19 wherein the phosphor SrₓAl_{y}O_{z}:Eu⁺², Dy⁺³ is produced, wherein x, y and z are integers from 1 to 23.

21. The product of the process of claim 11.
